(19) United States
(12) Patent Application Publication
(10) Pub. No.: US 2003/0130926 A1
(43) Pub. Date: Jul. 10, 2003

(54) Order processing for automated market system

(76) Inventors: Daniel F. Moore, New Haven, CT (US); John Hughes, Straford, CT (US)

Correspondence Address: FISH & RICHARDSON PC, 225 FRANKLIN ST, BOSTON, MA, 02110, US

(21) Appl. No.: 10/040,941

(22) Filed: Jan. 7, 2002

(51) Int. Cl. G06F 17/60

(52) U.S. Cl. 705/37

(57) ABSTRACT

An electronic market for trading of securities includes a plurality of client stations for entering quotes for securities and a server process that receives quotes from the clients, aggregates the quotes and causes a total of all aggregated quotes to be displayed for a plurality of price levels on the client systems. The market uses a graphical user that depicts aggregated quotes in an aggregate window a plurality of price levels of a product traded in the market. The market also includes processes to handle lock/cross market conditions, match-off of order flow and provides a central quote/order collector that interfaces to disparate order delivery systems to minimize dual liability of market makers.

### BACKGROUND

This invention relates to trading systems particularly financial trading systems.

Electronic equity markets, such as The Nasdaq Stock Market® collect, aggregate and display pre-trade information to market participants. In an electronic market pre-trade information takes the form of a quote that represents a single or an aggregate of same-priced principal or agency orders. A market such as Nasdaq also provides trading platforms through which market participants may access liquidity indicated in the marketplace. In such markets, trading occurs between market makers either for their own proprietary account or as agent to a customer. Also, other entities may display quotes or place orders for display in the market. For example, electronic communication networks, (ECNs) are one type.

### SUMMARY

According to an aspect of the present invention, a method of trading securities in an electronic market, includes receiving from an electronic communication network a grouped order representing customer orders that are grouped with respect to price. The method also includes assigning a time receipt to components of the grouped order and displaying interest associated with the grouped order as a quote. Thereafter, receiving from the electronic communication network subsequent grouped customer orders that are grouped with the initial interest according to price and assigning different time stamps to components of the subsequent grouped customer orders based on the time of receipt of the subsequent grouped orders and matching components of the grouped order against interest in the market based on how the components of the grouped order interact with interest in the market.

One or more of the following advantages may be provided by one or more aspects of the present invention.

An ECN can have its initial aggregated interest entered as a summary quote and any additional, subsequent interest represented as an order that receives a new time stamp, and is associated with the initial interest. Thus, the ECN can summarize, i.e., aggregate orders for their own trading interest sending that interest and additional interest to the system. An ECN can use the summary quote to send their book to the market while avoid showing their order detail to the market.

The summary quote allows ECN's or other market participants to give multiple quotes to the system. The summary quote allows interest to be represented in the system at multiple levels, unlike a quote which is only permitted at one level. The summary quote can indicate the capacity which the market maker is trading, principal, riskless principal, agency. The summary quote is comprised of individual underlying orders that are represented for display as a single order per price level but have different priorities, as to size and time and hence different execution or delivery interaction with the market. These priorities will be taken in consideration when components of the summary order are executed or delivered for an execution.

### BRIEF DESCRIPTION OF THE DRAWINGS

FIG. 1 is a block diagram of a market system.

FIG. 2A is a diagram showing a format for summary quotes.

FIG. 2B, a diagram showing a format for quotes.

FIG. 2C is a diagram showing an entry screen for orders

FIG. 3A is a block diagram showing arrangement of a quote/order collector facility.

FIG. 3B is a logic view of functions in the quote/order collector facility.

FIGS. 4A-4B are flow charts showing a quote/order manager.

FIG. 4C is a flow chart showing a montage manager.

FIG. 5 is a flow chart of an execution/routing manager.

FIG. 6 depicts the arrangement of FIGS. 6A-6D.

FIGS. 6A-6D are flow charts depicting details of the execution/routing process.

FIGS. 7A-7D are diagrams depicting aspects of a summary order.

FIG. 8 depicts a quote montage.

### DESCRIPTION

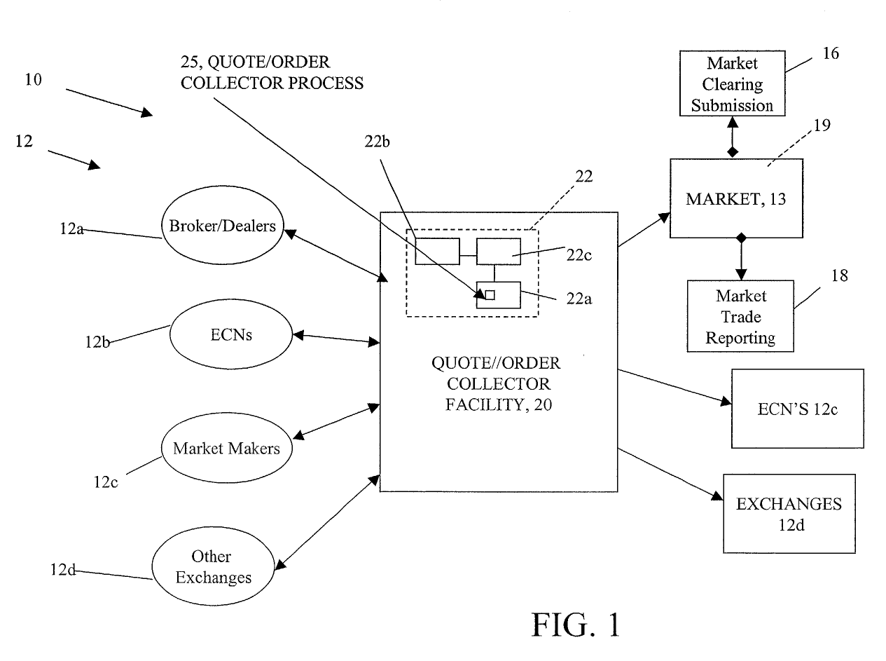

Referring to FIG. 1, an electronic market 10 is shown. The electronic market 10 includes client systems 12 that access a central quote/order collector facility 20. The client systems 12 can be broker/dealer systems 12a, electronic communication networks (ECN's) 12b, market-marker systems 12c, and other exchanges 12d. The connections can use existing Nasdaq protocols such as SelectNet®, Small Order Execution System^{SM} (SOES^{SM}), and so forth. The client systems 12 include a processor, memory and a storage device, e.g., a client workstation or personal computer (all not shown) that can include a client process to enter quotes/orders into the electronic market system 10. The quote/order collector facility 20 causes the order execution or order delivery systems (e.g., SOES^{SM} and SelectNet®) to deliver executions or orders to a market that is coupled to a clearing system 16 and a reporting system 18. It also causes delivery of executions or routing of orders to the ECN's 12c, depending on the status of the ECN, and routing of orders to other markets and exchanges 12d. The quote/order collector facility 20 is comprised of one or preferably a plurality of server computers generally denoted as 22 including a processor 22a, main memory 22b and storage 22c. The storage system 22c includes quote/order collector process 25 that is executed in memory 22b. In general, server 22 is a complex computer server, the details of which are not important to an understanding of the present invention.

The quote/order collector facility 25 collects pre-trade information in the form of quotes or orders. The distinction between a quote and an order depends on several factors. For example, each market maker can send a proprietary quote, i.e., a quote that represents its own trading interest, or an agency quote that represents trading interest of a sponsored entity. If one proprietary quote is sent it could be considered one order. If one agency quote is sent it also could be considered one order. If an agency quote reflects an aggregation of more than one agency order, however, the aggregate agency order could be considered a quote. Entering quotes are limited to registered market makers 12b and ECNs 12c and possible UTP Exchanges 12d. For any given stock, a registered market maker or ECN may directly enter a non-marketable order, i.e., quote into the system 20 on behalf of its customer account, or it may sponsor the direct entry of an order by its customer. All sponsored quotes are sent to the quote/order collector facility 20 under the name of the sponsoring market maker or ECN. Every registered market maker or ECN can submit an unlimited number of non-marketable quotes to the system 20.

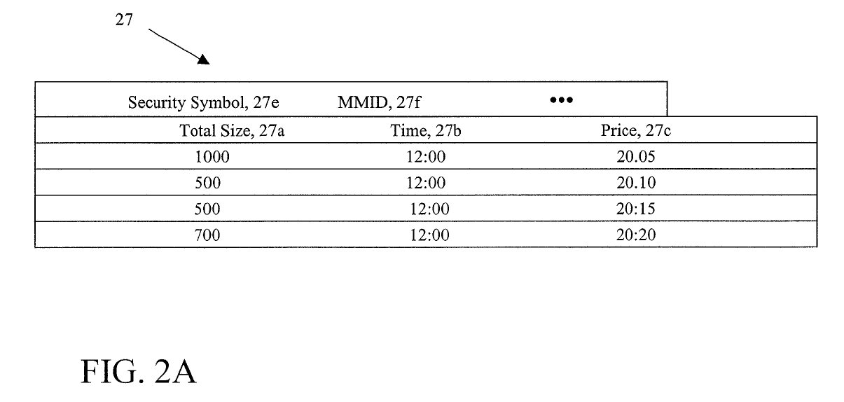

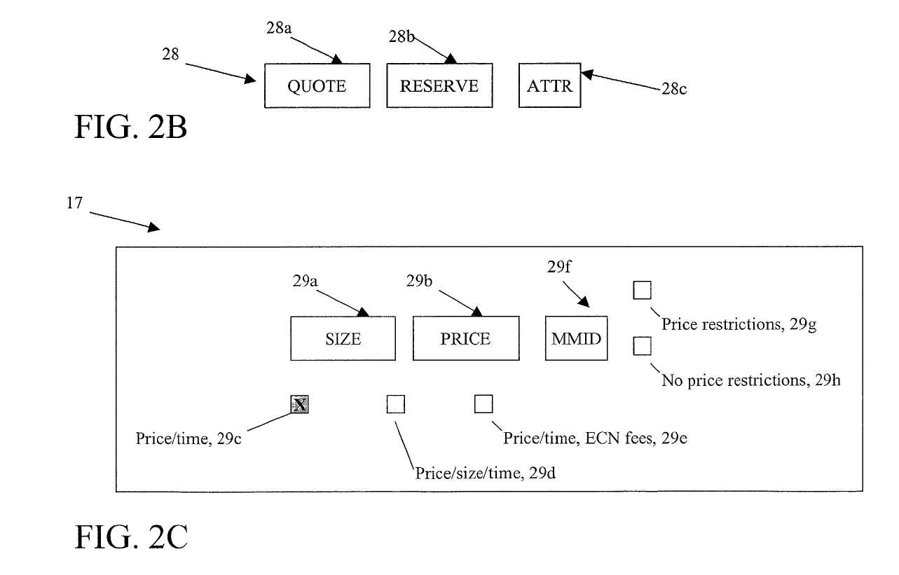

Referring to FIG. 2A, the system 10 accepts multiple quotes from an ECN in the form of a summary quote 27. An ECN can choose to aggregate orders in their own systems, avoiding showing order detail to the market. The ECN can deliver this aggregated interest at multiple price levels through the use of the summary quote 27 in the form of a quote. The summary quote 27 has a quantity or size field 27a that represents the trading size at a specific price level, a timestamp field 27b assigned by the system at the time the aggregated interest is entered into the system 10. The summary quote 27 also includes a price field 27c. In addition, convention data such as a security symbol 27d, MMID 27e, and so forth are included.

As additional interest comes into the ECN's system, the ECN sends that interest to the system. The new interest would be treated as an order receiving a new timestamp, and is added to the summary quote 27. The new interest would interact in the market according to the timestamp and other priorities specified in the new order.

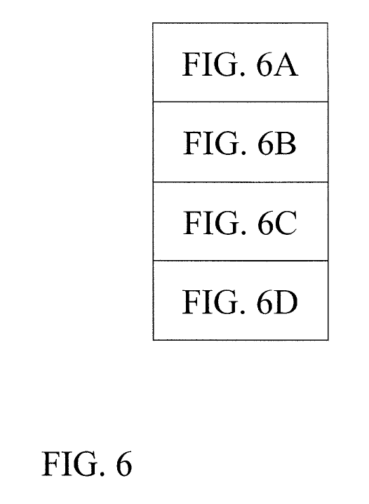

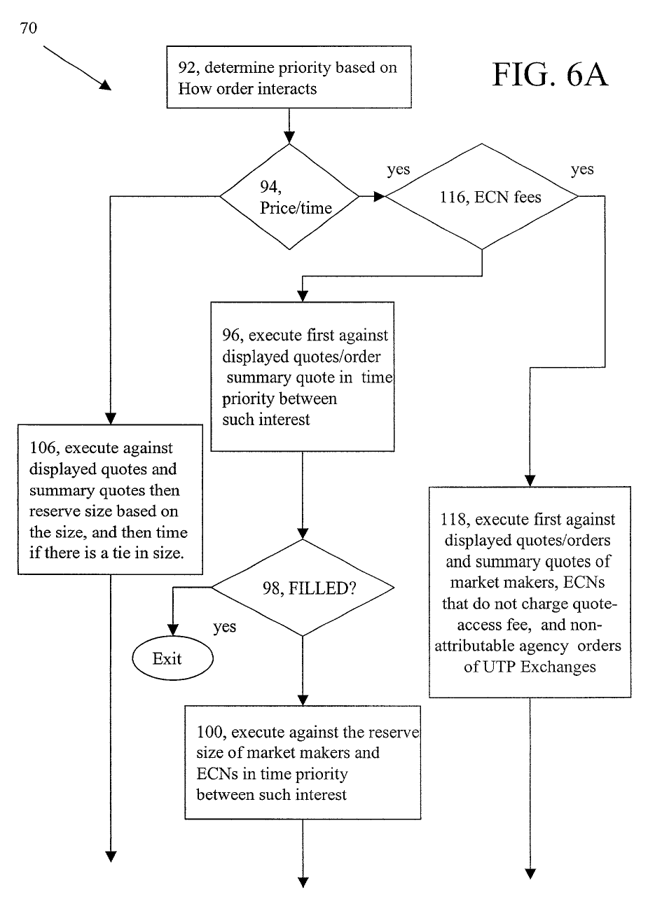

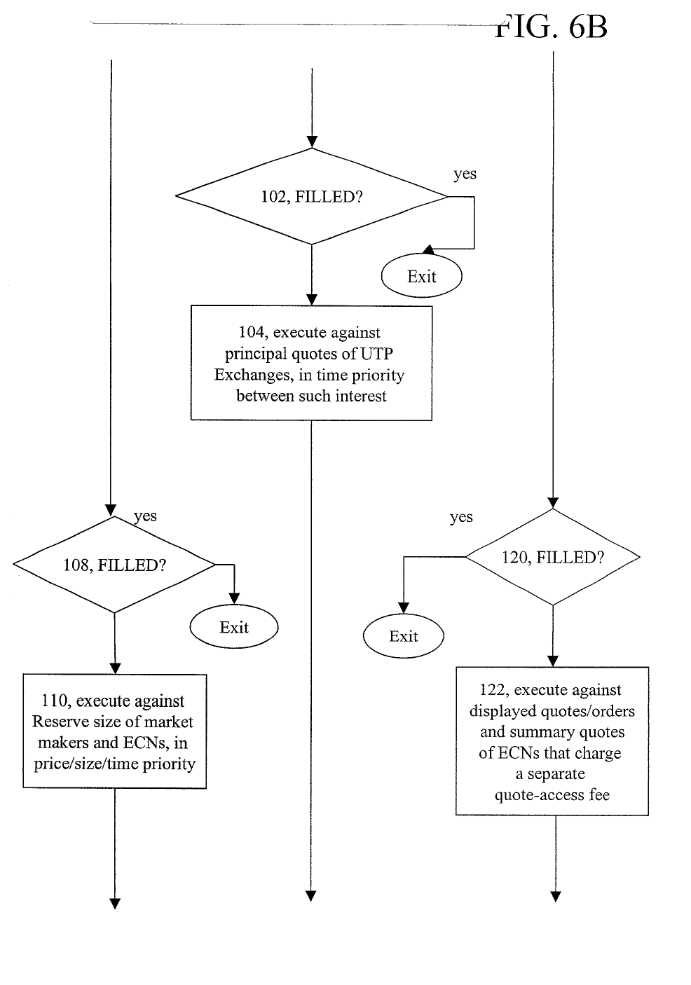

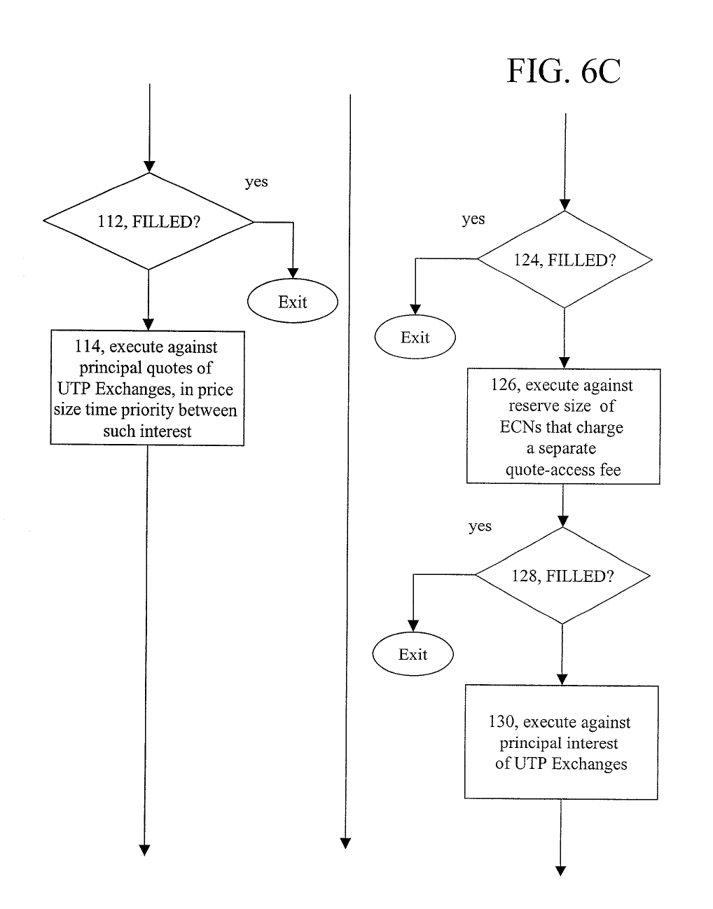

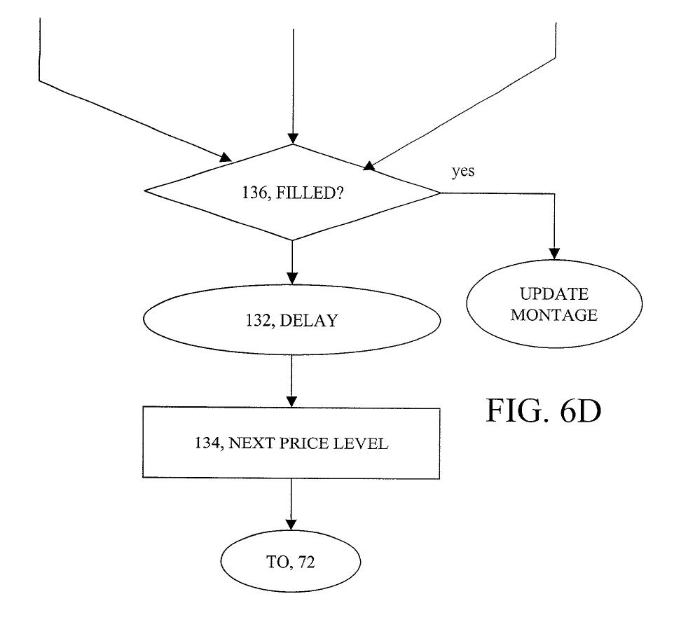

Simplified data structure representations of summary quotes and how the summary quote is reflected in the market system 10 are depicted in FIGS. 6A-6D.

The summary quote allows interest to be represented in the system at multiple levels, unlike a quote which is only permitted at one level. The summary quote can indicate the capacity which the market maker is trading, principal, riskless principal, agency. In some embodiments of the system with quotes the trading capacity can be represented, whereas in others the capacity is not displayed. The summary quote 27 can also indicate short sell status on the summary quote 27.

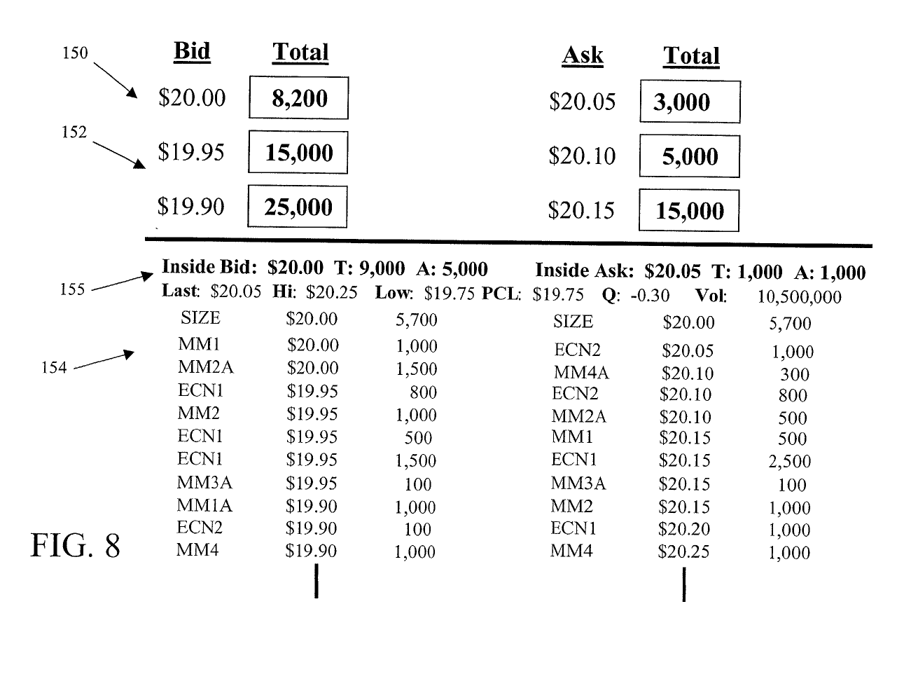

Referring to FIG. 2B, quotes 28 submitted to the electronic market system 10 can include a displayed quote size 28a, a reserve size 28b and an indication 28c (ATTR) of whether the quote size is attributable or non-attributable. Quote size 28a, when attributable based on indicator 28c, is directly attributable to the market maker or ECN and is displayed in a “current quote” montage an order display window 150 to be discussed below in FIG. 8. Quote size 28b when non-attributable is the size that the market maker or ECN wishes to display to the marketplace through an aggregate montage of the order display window 150 discussed below. This quote size 28a is not attributable to the market maker or ECN until it is executed. Reserve size 28b is the size that is not displayed to the marketplace but that is immediately accessible through the quote/order collector facility 20. In order to use reserve size 28b, a market maker can be required to have a minimum amount displayed in the aggregate quote size 28a without attributable indicator 28c.

Referring to FIG. 2C, an entry screen 29 for non-directed order entry is shown. The screen 29 allows a participant to enter non-directed orders and would generally include fields 29a-29e for entering information including price, amount, and also three type fields. The type fields 29c-29e determine how the order interacts in the execution/routing manager 26d against Quoting Market Participant's contra-side quotes/orders. The type fields choose a priority, e.g., price/time box 29c; or price/size/time box 29d; or price/time that accounts for ECN access fees box 29e.

The screen 29 can also have a field 29f to enter a quoting market participant's symbol for the purpose of entering preferenced orders. Optionally, the screen 29 can have fields 29g, 29h to indicate a preference order type, e.g., a preferenced order that has price restrictions box 29g or a preferenced order that does not have price restrictions box 29h. Alternatively, the electronic market system 10 can be configured to accept only one type of preferenced order and not the other.

Order Collector Facility

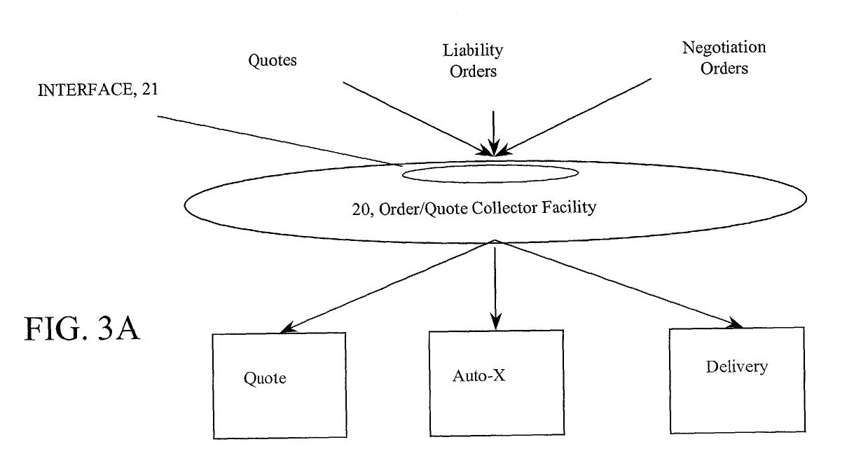

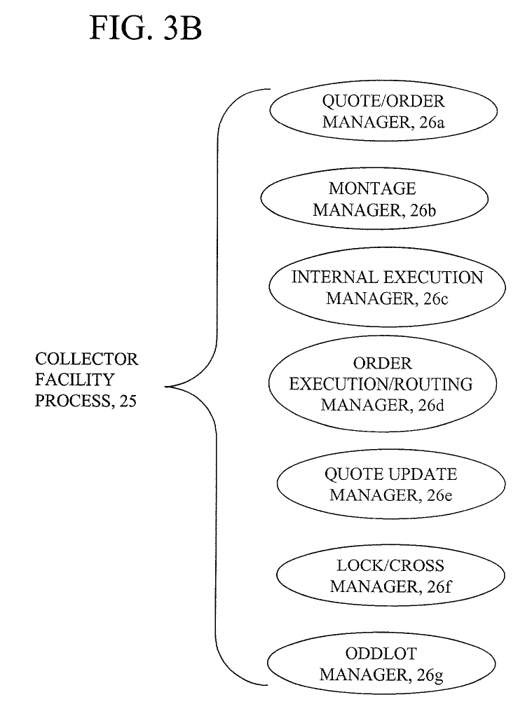

Referring to FIG. 3A, the quote/order collector facility 20 receives quotes and summary quotes 27 from market participants. The quote/order collector facility 20 allows a quote/order and summary quotes 27 to be displayed in the market, and also allows for marketable orders to be executed or routed to market participants.

The order quote collector facility 20 also includes an interface 21 that couples the order collector facility 20 to a plurality of order delivery systems. For example, the interface 21 can couple the order quote collector facility 20 to an order execution system, e.g., the Small Order Execution System® (SOES^{SM}) and to an order delivery and negotiation system, e.g., SelectNet®. The interface 21 would provide access to information contained in order flow delivered via the delivery systems to a quote/order collection process 25 described in conjunction with FIG. 3B. In general, the electrical and logical functions which comprise the interface 21 can be similar to the ones currently existing in the SOES^{SM}/SelectNet® systems. The interface 21 or the process 25 would extract information from the quotes and make that information available to the quote order collector process 25. The quote/order collector process 25 extracts information and processes orders allow the order collector system 20 to be a unifying point of collection of all orders which are sent to the market 10.

The interface 21 can also be used to route executions of liability orders back to market participants whose quotes/orders were executed against and can deliver orders, both liability orders for execution or non-liability orders for negotiation against market participants whose quotes are selected for further negotiation via the SelectNet® systems.

Referring to FIG. 3B, the quote/order collector process 25 is shown. The quote/order collector process 25 provides transmission of multiple orders or quotes at multiple price levels by Quoting Market Participants to a quotation manager 26a. The quote/order process 25 also handles summary quotes. The quote/order manager 26a provides a unified point of entry of quotes and orders from disparate delivery systems into the quote/order collector facility 20 to access quotes/orders and summary quotes 27 displayed (as either attributable or non-attributable) in both the aggregate montage and quote montage, as discussed below. The quote/order manager 26a manages multiple quotes/orders and quotes/orders at multiple price levels and summary quotes. The quote/order manager 26a uses a montage manager 26b to display (either in the Aggregate montage or in the current quote montage) the orders/quotes and summary quotes consistent with an order's/quote's parameters. The order collector process 25 can also include an internal execution process manager 26c to match off executions for quoting market participants at the best bid/offer. The order collector system 20 also includes an order routing/execution manager 26d providing a single point delivery of executions or routing of orders, which substantially eliminates potential for dual liability. That is, order collector process 25 will maintain the order routing and executions functionality available in the SOES^{SM} and SelectNet® systems. The order collector process 25 can also includes a quote update manager 26e, a lock/cross quote manager 26f, and an odd lot execution manager 26g.

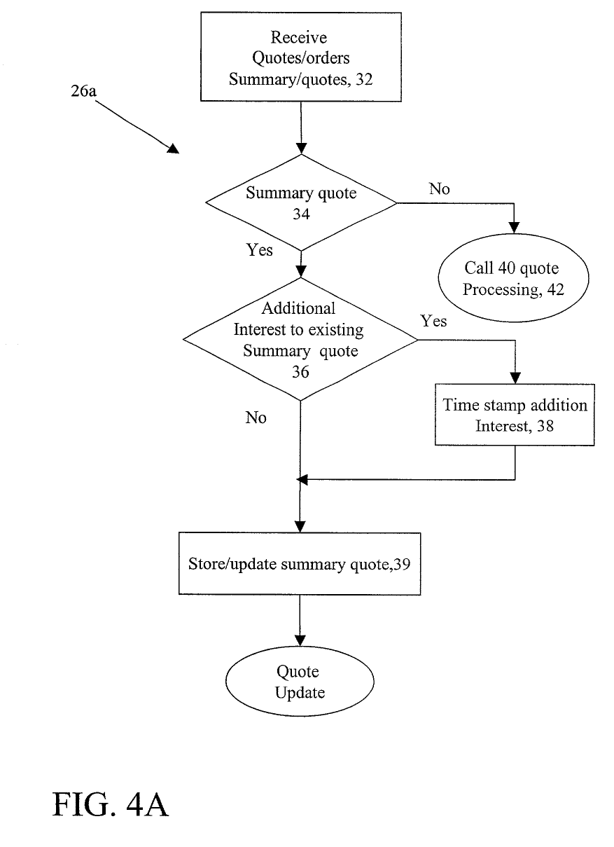

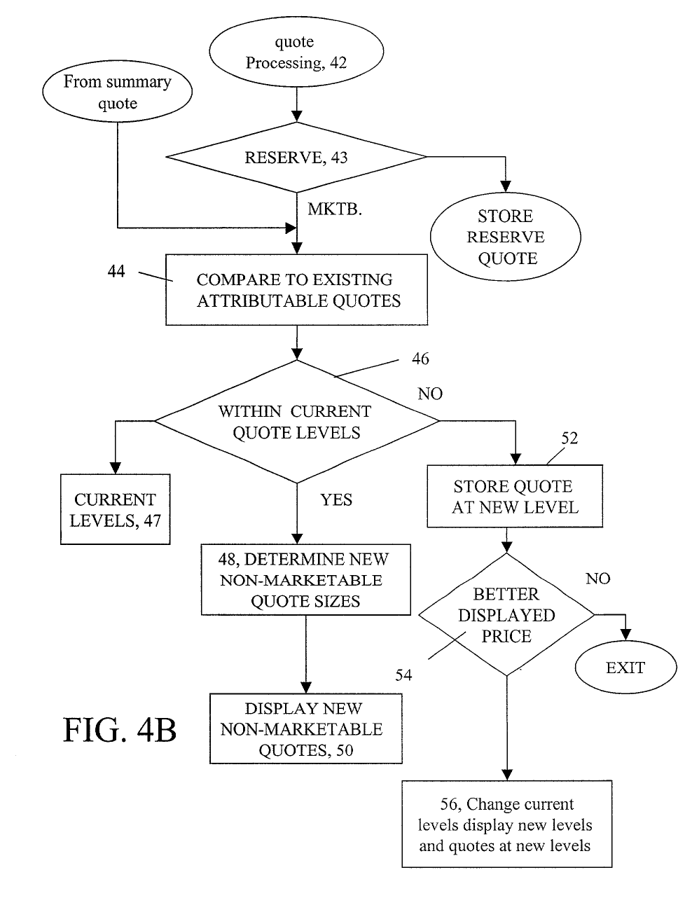

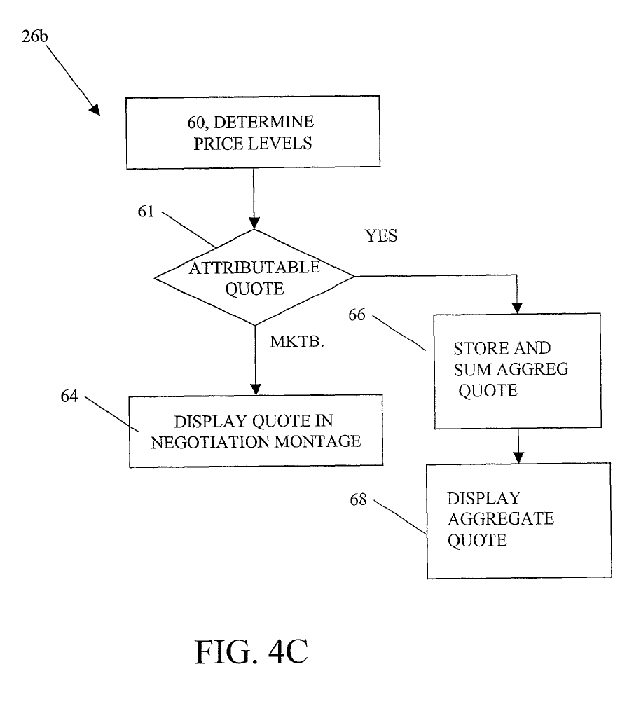

Referring to FIG. 4A, the order collector process 25 executes the quote/order manager 26a. The quote/order manager 26a receives orders/quotes and summary quotes and time stamps each order/quote upon receipt. This time stamp determines the order's/quote's ranking for automated execution. Quotes/orders are designated as either attributable or non-attributable, and could also have a reserve size discussed above. The order collector process 25 aggregates all of a Quoting Market Participant's attributable and non-attributable orders at a particular price level, and disseminates order/quotation information into the aggregate montage and/or the current quote montage, as will be discussed below.

In one embodiment, the quote/order manager 26a receives 32 quotes and determines 34 whether the received quote is a summary quote, and if so it determines 36 if it is additional interest to an already existing summary quote. As mentioned, the summary quote includes quotes at multiple price levels that receive 38 the time-stamp at the time the interest is entered into the system 10. Throughout trading, as additional interest comes into the ECN's system, the ECN sends that interest to the system 10. The new interest would be treated as an order receiving a timestamp, but would be included in the summary quote above receiving 38 the time stamp of when the additional interest was received by the system. The system then stores/updates 39 the summary quote and enters quote processing 42 at 44. This, of course, happens on an individual basis for each security traded in the system.

If the received quote is not a summary quote, the order entry process 25 calls 40 the quote processing 42 (FIG. 4A). Quote processing 42 determines 43 whether the received quote/order corresponds reserve interest. If the quote does not correspond to reserve interest then the quote is a displayable quote that is attributable or non-attributable.

The order entry process 25 compares 44 the received quotes/orders or summary quotes to existing quotes/orders to determine 46 whether the price of quotes/orders fall in existing quote/order price levels. Any number of quote/order price levels can be accommodated although in this example, only three to five price levels will be displayed in the non-attributable i.e., aggregate montage. If the quote price is in a displayable price level it is a displayable quote eligible for automated execution. The order collector system 20 can be provided with more price level depth than the three levels, e.g., a depth of 20-25 levels although only a limited number, e.g., three or five would be displayed at any one time. Interest at each price level and components of that interest, (e.g., initial interest as distinguished from additional interest that receives new time stamps) will be examined in a similar manner as if they were individually entered.

If the quote is within one of the pre-defined quote levels, the process 25 determines 48 new non-marketable quote/orders sizes by adding the quote/order size corresponding to the received quote/order to quote sizes at that price level already in the system 20. The process 25 will cause the new non-marketable quote sizes to be displayed 50. If the quote is not within one of the pre-defined quote levels, the process 25 stores 52 the quote at a new price level determines 54 if it is at a better price. If the quote is at a better price, the process 25 changes 56 current levels to cause a new price level for non-marketable quote sizes to be displayed 50.

Referring to FIG. 4C, the montage manager 26b of the quote/order collector process 25 determines 60 which price levels to display and determines 61 if an order or a summary quote 27 is a non-attributable order. If the order is non-attributable, the quote/order collector process 25 will store and sum 66 the quote with like quotes to produce an aggregated quote and display 68 the aggregate size of such orders in the aggregate montage when the orders fall within one of the three top price levels. For attributable orders, the aggregate size of such orders is displayed in the current quote montage once the order(s) at a particular price level becomes the particular quoting market participant's best attributable bid or offer in the current quote montage. This interest will also be aggregated and included in the aggregate montage if it is within the displayed price levels. Market makers and ECNs can have one MMID and possibly an agency MMID against which they can display attributable quotes. If a market maker has an agency quote, attributable orders will be displayed once the order or orders at a particular price level become the market participant's best agency quote.

Quote/order collector system 20 provides several advantages to the market. One advantage is that it ensures compliance with the regulatory rules such as the SEC Order Handling Rules, and in particular the Limit Order Display Rule and SEC Firm Quote Rule. With system 20 it is less likely that a Quoting Market Participant, because of system delays and or/fast moving markets, will miss a market because the Quoting Market Participant is unable to quickly transmit to system 20 a revised quote (which may represent a limit order).

Nondirected Orders

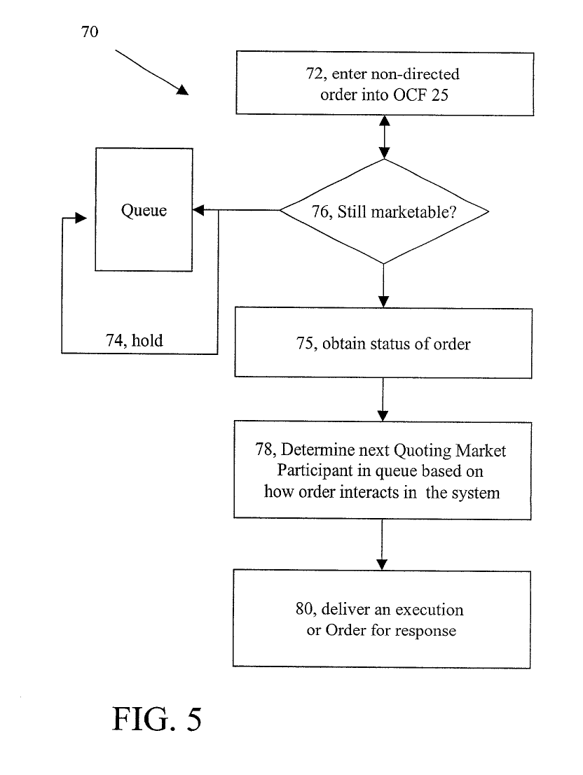

Referring to FIG. 5, the market 10 allows market participants that enter Non-Directed Orders three options as to how the order interacts with the quotes/orders in the system 20. An exemplary format was described above in FIG. 2C. These choices are that the orders can execute against displayed contra side interest in strict price/time; or price/size/time; or price/time that accounts for ECN access fees. This can be set by selecting one of the options on the order entry screen (FIG. 2C). As a default, the system 20 can execute Non-Directed Orders in general price/time priority. A non-directed order is an order that is not executed or routed for response to a particular Quoting Market Participant, e.g., a particular market maker or ECN.

A market participant can immediately access the best prices in system 20, as displayed in the aggregate montage, by entering 72 a non-directed order into the OCF 25. A non-directed order is designated as a market order or a marketable limit order and is considered a “Liability Order” and treated as such by the receiving market participant. If a non-directed limit order is marketable when entered into the system 20, but subsequently becomes non-marketable because of a change in the inside market, the system 20 may hold 74 the order for e.g., 90 seconds and not immediately return the order to the participant. If within the holding period e.g., 90 seconds, the order once again becomes marketable 75, the system 20 will execute/send the order to the next Quoting Market Participant in the non-directed order queue. Additionally, the order entry participant can obtain 76 the status of the order and request a cancel of such order (not shown). In some embodiments, the hold period can be less or can be eliminated and also can be selectively applied to market participants depending on how they participate in the market.

Upon entry, the OCF 25 will determine 78 what market participant is the next Quoting Market Participant in queue to receive an order, based on how the participant desires to have the order interact in the system 20. Depending on how that receiving Quoting Market Participant participates in system 20 (i.e., automatic execution v. order delivery), the OCF 25 will either cause an execution or delivery of an execution.

Order Execution Manager

FIGS. 6, 6A-6D, show processing in the order execution/routing manager 26d. The order execution/routing manager 26d will execute non-directed orders against Quoting Market Participant's quotes/orders based on the chosen priority, specified by the order, e.g., contra side interest in strict price/time; or price/size/time; or price/time that accounts for ECN access fees priority and in accordance with details of summary quotes. Thus, for example, a summary quote 27 can be represented as a single entry per price level in the market, but is comprised of individual underlying orders that may have different priorities for execution or delivery, as to size and time. These priorities will be taken in consideration when components of the summary order are executed or matched and delivered for execution.

As noted above, each quote/order when entered into the OCF 25 receives a time stamp. The order execution/routing manager 26d will deliver all orders at the best bid/best offer in chosen priority. The order execution/routing manager 26d can first attempt to provide a match off of orders/quotes and summary quotes entered by a Quoting Market Participant if the participant is at the best bid/best offer by calling the internal execution manager 26c (FIG. 3A). Thus, the order execution/routing manager 26d will call the internal order execution manager 26c to try to match off a Quoting Market Participant's orders and quotes that are in the system 20 if the participant is at the BBO and receives a market or marketable limit order on the other size of the market.

The system 20 has a default, e.g., a strict price/time priority. If a market participant does not override the default or selects price/time 94, (FIG. 6A) a Non-Directed Order would be executed 96 first against all displayed quotes/order and summary quotes of market makers, ECNs, and non-attributable agency orders of UTP Exchanges, in time priority between such interest. If the order is not satisfied 98 at that level of priority the order will execute 100 against the reserve size of market makers and ECNs in time priority between such interest. Note that for summary quotes, the time of receipt of components of the summary quote 27 can affect the priority of how the entire summary quote interacts in the market. Thus, if at a given price level, there is other market interest having a higher priority than for instance some of the additional interest that came to the summary quote, that market interest would be executed or matched ahead of the additional interest in the summary quote 27, despite that a portion of the summary quote 27 may execute ahead of the other market interest.

If the order still is not satisfied 102, (FIG. 6B) the order will execute 104 against principal quotes of UTP Exchanges, in time priority between such interest.

Alternatively, a market participant can indicate that the orders execute against contra side interest on a price/size/time basis. A Non-Directed Order would execute 106 (FIG. 6A) against displayed quotes and then reserve size based on the size of the displayed quote, and then time if there is a tie in size. Reserve size is executed against based on the size of the related displayed quote/order, not the total amount held in reserve. Under this option, orders are processed first against displayed quotes/orders and summary quotes of market makers, ECNs, and agency quotes/orders of UTP Exchanges in price/size/time priority between such interest. Again for summary quotes 27, the time of receipt of components of the summary quote 27 can affect the priority of how the entire summary quote interacts in the market, as described above.

If the order is not satisfied 108 (FIG. 6B) at that level of priority the order will execute 110 against reserve size of market makers and ECNs, in price/size/time priority of such interest, with size priority based on the size of the related displayed quote/order. If the order is still not satisfied 112 (FIG. 6C) at that level of priority the order will execute 114 against principal quotes of UTP Exchanges, in price/size/time priority between such interest.

A third choice enables a market participant to indicate that their order should be executed in a manner that accounts for ECNs quote-access fees. If a market participant selects this option 116, (FIG. 6A) Non-Directed Orders execute 118 (FIG. 6A) first against displayed quotes/orders and summary quotes of market makers, ECNs that do not charge a separate quote-access fee, and non-attributable agency orders of UTP Exchanges. The order can also execute against the quotes/orders and summary quotes of ECNs that charge a separate quote-access fee where the ECN indicates that price improvement offered by the quote/order is equal to or exceeds the quote-access fee. The execution is in time priority between such interest and for summary quotes, the time of receipt of components of the summary quote can affect the priority of how the entire summary quote interacts in the market, as described above.

If the order is not satisfied 120 (FIG. 6B) at that level of priority the order will execute 122 against displayed quotes/orders of ECNs that charge a separate quote-access fee to non-subscribers. If the order is not satisfied at that level of priority the order will execute against reserve size of market makers and ECNs that do not charge a separate quote-access fee to non-subscribers, as well as reserve size of quotes/orders from ECNs that charge a separate quote-access fee to non-subscribers where the ECN entering such quote/order has indicated that the price improvement offered is equal to or exceeds the quote-access fee. Execution is in time priority between such interest. If the order is not satisfied 124 (FIG. 6C) at that level of priority the order will execute 126 against the reserve size of ECNs that charge a separate quote-access fee to non-subscriber, in time priority between such interest. If the order is not satisfied 128 at that level of priority the order will execute 130 against principal interest of UTP Exchanges, in time priority between such interest.

With all three approaches, the market 10 could make an exception for Non-Directed Orders entered by a market participant when that market participant is also at the inside market. In that case, the system 20 could match off the Non-Directed Order to buy/sell against that market participant's inside quote/order to sell/buy, in lieu of sending it to the participant next in the queue.

Referring to FIG. 6D, if the order is not filled 136, the order execution/routing manager 26d will move 134 to the next price level, after a predefined delay, e.g., a 5 second interval delay 132 before attempting to execute an order at the new price level. The price-level interval delay will give market participants time to adjust their quotes and trading interests before the market moves precipitously through multiple price levels, which may occur when there is news, rumors, or significant market events. Thus, the price-level interval delay is a modest and reasonable attempt to limit volatility. In some embodiments this delay can be eliminated.

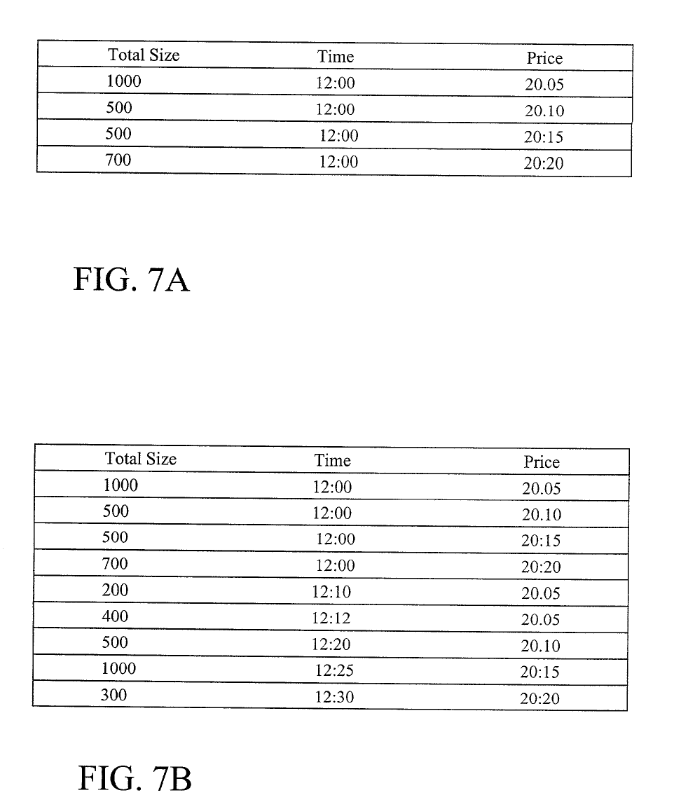

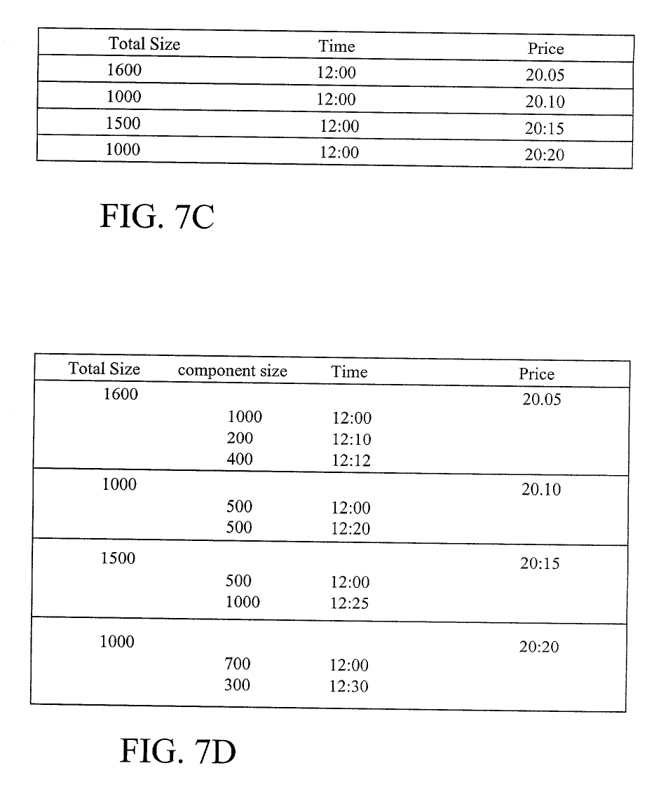

Referring to FIGS. 7A-7D, simplified data structures that represent orders aggregated into a summary quote are shown on the ask side of the market.

FIG. 7A shows initial multiple quotes in the form of a summary quote received from an ECN that chose to aggregate its orders. This initial interest is ordered by price and receives a common time stamp of 12:00 the time at which the aggregated interest is entered into the system. FIG. 7B shows additional interest from the ECN that was entered into the system prior to any of the interest being matched. The additional interest receives a timestamp of its entry in the system at times 12:00:10; 12:00:12:; 12:00:20; 12:00:25 and 12:00:30 (here time stamped to the hundredth of a second, but any increment could be used). The new interest interacts in the market according to the various time stamps.

FIG. 7C shows ECN initial aggregated interest and additional interest is displayed to the market single quotes. FIG. 7D shows that within each price level the interest in the price level may interact with the market in a different manner, taking into consideration time of receipt of each component of the interest. Additional details that would be used to represent this interest is not shown such as details of the interest (which customer, account, etc) that could be kept by the ECN. Also, not shown is an identifier of the capacity at which the market maker is trading, e.g., principal, riskless principal, agency.

Referring to FIG. 8, the system 20 produces a composite montage 150. One component of the composite montage 150 is an aggregate montage that shows aggregated interest at 3 or more price levels in the market. In a typical embodiment five levels would be displayed. The montage also includes a quote montage 154 that would include displayed quotes from ECN's derived from the summary quote. The quote montage 154 shows for a particular stock two columns (one for bid, one for ask), under which is listed the MMIDs for each registered market maker, ECN, and UTP Exchange in the particular stock and the corresponding quote (price and size) next to the MMID. System 20 ranks the bids and offers along with the corresponding MMID in price/time priority. Accordingly, the market participant at the best bid who is first in time appears first in the montage, the market participant at the best bid (or the next best bid) who is next in time is ranked second, and so forth. A market minder window 155 is also shown.

The quote montage 154 also includes a special MMID (here referred to as “SIZE”) that represents the aggregate size of all non-attributable quotes/orders at the best bid/best offer displayed in the current quote montage 154. There is one “SIZE” MMID for the bid and offer side of the market.

### Other Embodiments

Other embodiments are within the scope of the following claims.

What is claimed is:

1. A method of trading securities in an electronic market, the method comprises:
receiving from an electronic communication network a grouped order representing customer orders that are grouped with respect to price;
assigning a time receipt to components of the grouped order;
displaying interest associated with the grouped order as a quote; and thereafter
receiving from the electronic communication network subsequent grouped customer orders that are grouped with the initial interest according to price and assigning different time stamps to components of the subsequent grouped customer orders based on the time of receipt of the subsequent grouped orders; and
matching components of the grouped order against interest in the market based on how the components of the grouped order interact with interest in the market.

2. The method of claim 1 wherein the components interact with the market based on a priority type selected for contra side orders in the market.

3. The method of claim 1 wherein the choices include executing the order against displayed contra side interest in priority that is strict price/time, or price/size/time, or price/time that accounts for ECN access fees.

4. The method of claim 1 wherein displaying initial interest and subsequent interest is based on the total of such interest without regard to time of receipt of the interest.

5. The method of claim 1 wherein displaying initial interest and subsequent interest is displayed as a quote in a quote montage.

6. The method of claim 1 wherein displaying initial interest and subsequent interest is displayed as a quote in a quote montage with other interest of market makers, other ECNs, and non-attributable agency orders of UTP Exchanges, in a specified priority between such interest.
